(19) United States
(12) Patent Application Publication
(10) Pub. No.: US 2022/0328920 A1
(43) Pub. Date: Oct. 13, 2022

(54) BATTERY PACKS FOR ELECTRIC BICYCLES

(71) Applicant: Rad Power Bikes Inc., Seattle, WA (US)

(72) Inventors: G. Kyle LOBISSER, Seattle, WA (US); Derek GUTHEIL, Seattle, WA (US)

(21) Appl. No.: 17/714,734

(22) Filed: Apr. 6, 2022

Related U.S. Application Data
(60) Provisional application No. 63/171,863, filed on Apr. 7, 2021.
(60) Provisional application No. 63/291,656, filed on Dec. 20, 2021.

(51) Int. Cl. H01M 50/213; H01M 50/291; H01M 50/505; H01M 50/249; H01M 50/242; H01M 50/24

(52) U.S. Cl. CPC H01M 50/213; H01M 50/291; H01M 50/505; H01M 50/249; H01M 50/242; H01M 50/24; H01M 2220/20

(57) ABSTRACT

A battery pack and battery pack chassis are described. The battery pack includes a chassis that is configured to position multiple cells proximate to one another within the pack, while also providing areas through which a potting compound can flow and contact the cells. For example, the chassis can include spacers or ribs that separate the cells, in some cases in asymmetric configurations, such that the potting compound contacts the outer surface of each battery cell within the pack. The chassis, in some cases, can also facilitate the connection of a bus bar between battery cells.

### CROSS REFERENCE TO RELATED APPLICATIONS

This application claims priority to U.S. Provisional Patent Application No. 63/171,863, filed on Apr. 7, 2021, entitled BATTERY PACK CHASSIS AND ASSOCIATED BATTERY PACK and U.S. Provisional Patent Application No. 63/291,656, filed on Dec. 20, 2021, entitled BATTERY PACK HAVING ASYMMETRICALLY SPACED BATTERY CELLS, both of which are incorporated by reference in their entirety.

### BACKGROUND

Electric bicycles, or e-bikes, are a popular method of transportation for use by individual riders, families, commercial enterprises and fleets, and so on. Unlike traditional bikes, an e-bike provides assisted modes of travel to a rider, including a peddle assist mode that utilizes power from a motor to assist the rider in pedaling and/or a throttle mode where the motor, when engaged, powers the e-bike without any pedaling from the rider.

Electric bicycles are powered by electric batteries, such as one or more battery packs having multiple battery cells. Conventional battery packs align the cells in series and/or parallel, often positioned right next to one another within a chassis of the battery pack. Often, such configurations can lead to the movement of the cells within the pack, causing inefficiencies, damage, or, at times, dangerous operation conditions.

### BRIEF DESCRIPTION OF THE DRAWINGS

Embodiments of the present technology will be described and explained through the use of the accompanying drawings.

FIGS. 1A-1B are diagrams illustrating an example battery pack.

FIGS. 2A-2B are diagrams illustrating a top surface of the battery pack.

FIG. 3 is a diagram illustrating cells positioned between spacers of a battery pack chassis.

FIGS. 4A-4B are diagrams illustrating a cross-sectional view of cells positioned within the battery pack.

FIG. 5 is a diagram illustrating a snap-fit battery pack.

FIGS. 6A-6B are diagrams illustrating a battery pack after application of the potting compound.

FIG. 7 is a flow diagram illustrating an example method of manufacturing a battery pack.

FIGS. 8A-8B are diagrams illustrating a battery pack having asymmetrically spaced battery cells.

FIG. 9 is a diagram illustrating a battery pack having different cell spacing regions.

FIG. 10 is a diagram illustrating a battery pack having eccentric spacing between cells.

FIG. 11 is a flow diagram illustrating an example method of configuring a cell layout for a potted battery pack.

In the drawings, some components are not drawn to scale, and some components can be combined for discussion of some of the implementations of the present technology. Moreover, while the technology is amenable to various modifications and alternative forms, specific implementations have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

A battery pack and battery pack chassis are described. The battery pack includes a chassis that is configured to position multiple cells proximate to one another within the pack, while also providing areas through which a potting compound can flow and contact the cells. For example, the chassis can include spacers or ribs that separate the cells such that the potting compound contacts most or all of an outer surface of each cell within the pack.

Utilizing a potting compound enables the battery pack to protect the battery cells by reinforcing the cells when positioned within the pack and to prevent or mitigate exposure to moisture, shocks, vibrations, and so on. Thus, the battery pack, having a chassis configured to house battery cells in a spaced, mechanically secure configuration, can be safer and more reliable when utilized for an electric bicycle or other micro-mobility vehicle. For example, utilizing a urethane based potting compound can eliminate or reduce corrosion, damage due to vibration, and can prevent or mitigate thermal runaway, among other benefits.

Further, the battery pack can include a chassis that spaces the battery cells in an asymmetrical alignment. For example, the battery pack can include an area having battery cells aligned in a first spaced configuration and an area having battery cells aligned in a second, different, spaced configuration. The spaced configurations can vary in several ways, such as in a size, length, or width between cells, the geometry, or positions, of the cells within an area, and so on. Such asymmetric alignment of the battery cells within a pack can mitigate thermal runaway with the battery pack by facilitating certain areas of the pack (e.g., areas that are often hotter than other areas) to include more potting material than the other areas.

While the battery packs and associated chasses are described with respect to, or for use by, an electric bicycle, the battery packs and/or chasses for described herein can be configured or utilized with other bicycles or cycles, electric scooters or other wheeled micro-mobility vehicles, mopeds, other electric vehicles, electrically powered tools or equipment, and so on.

Various embodiments of the technology will now be described. The following description provides specific details for a thorough understanding and an enabling description of these embodiments. One skilled in the art will understand, however, that these embodiments may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments.

### Examples of the Battery Pack Chassis

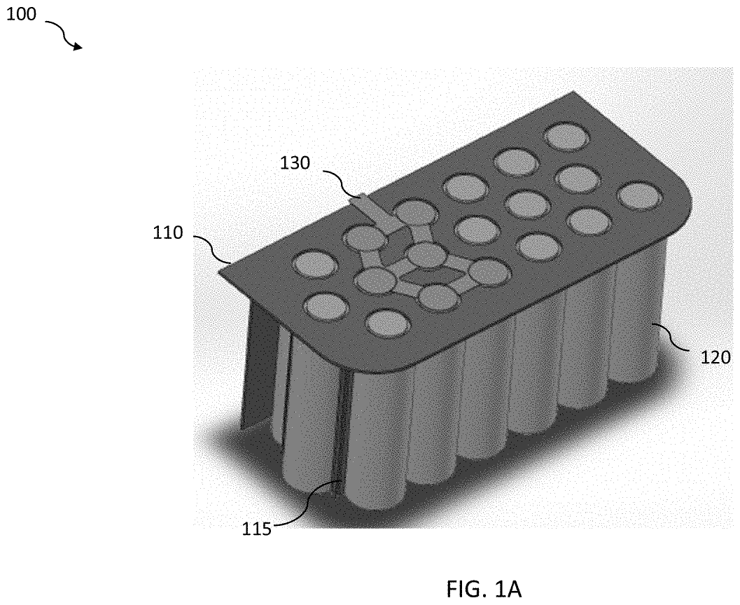

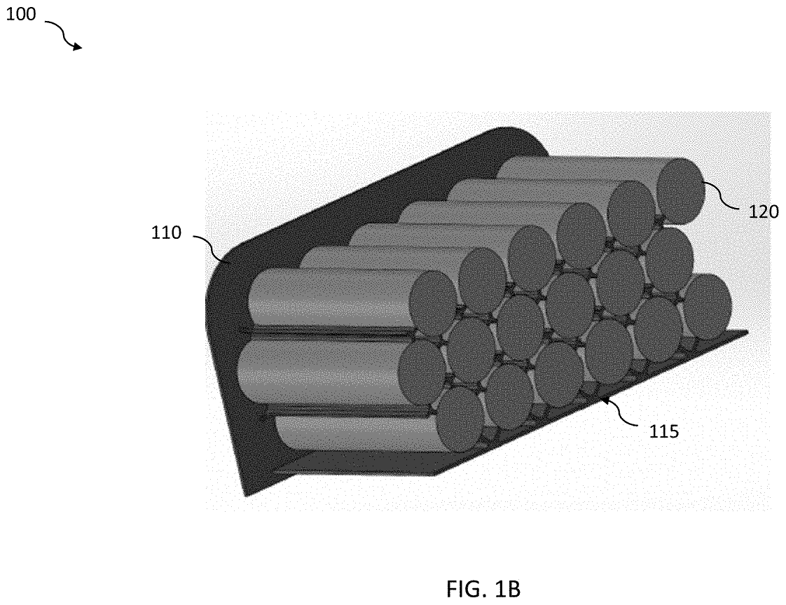

As described herein, a battery pack is configured to house multiple battery cells in a spaced configuration. FIGS. 1A-1B are diagrams illustrating a battery pack 100. The battery pack 100 includes a chassis 110, multiple battery cells 120, and a bus bar 130 or electrical connection material that connects the cells 120 together on a top surface of the chassis 110.

The chassis 110 included multiple spacers 115 that are positioned between the battery cells 120. The spacers 115 can be, for example, vertically extending ribs that sit between battery cells 120 (e.g., between three surrounding battery cells 120). The spacers 115 maintaining an opening between the battery cells 120, such that the opening extends in a vertical direction from a top portion of the chassis 110 to a bottom portion of the chassis 110.

Thus, in some embodiments, the battery pack 100 incorporates various design features to maximize the benefits of potting, such as using a urethane based potting compound to encapsulate or fix the battery cells 120 within the chassis 110 of the pack 100.

While depicted as having fewer cells, the chassis 110 can accommodate or be utilized by a battery pack configured to hold different amounts of cells, such as packs that hold 52 Lithium-ion (Li-ion) 18650 battery cells, packs that hold 39 Li-ion 21700 battery cells, and so on. Further, the chassis 110 can be designed to be part of a battery housing that includes a sled configured to receive and hold the chassis and associated cells and one or more lids (e.g., a 5-sided lid) that closes over the chassis and cells once the potting compound has been disposed.

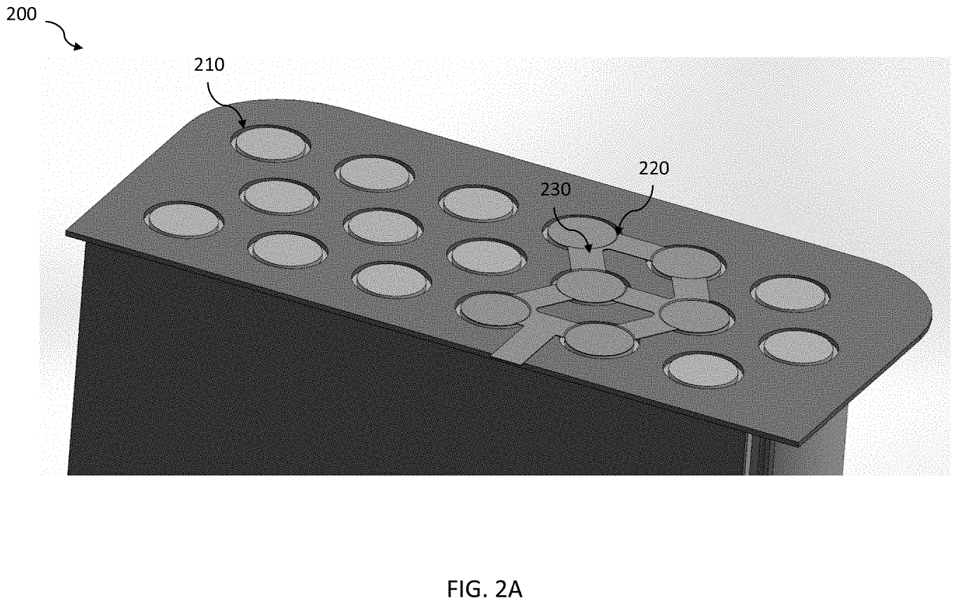

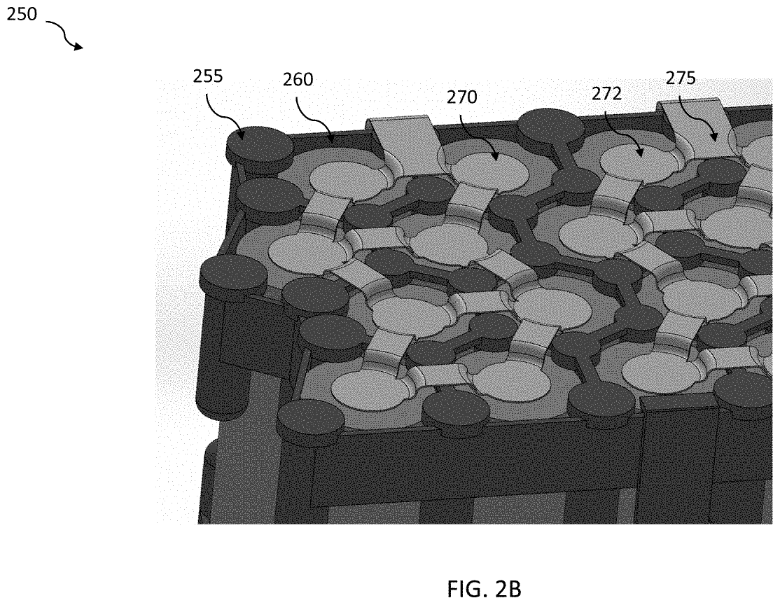

FIG. 2A is a diagram illustrating a top surface 200 of the battery pack. As depicted, a negative terminal of a battery cell is covered by the top surface 200. The surface includes holes or openings 210, which facilitate access to the cells. A bus bar 220 (e.g., formed of nickel) can undergo a stamping process to form a bridge 230 across cells. Thus, the surface 200, via gaps formed between the cells and the surface 200, allows an applied potting compound to wick and flow between the surfaces and provide greater structural support and short protection to the pack 100.

FIG. 2B depicts another top surface 250 of the battery pack. As described herein, the chassis 255 separates the battery cells 260, which are connected via a stamped bus bar 270. The top surface 250 has three-dimensional (3D) elements, and the bus bar 270, when stamped or otherwise applied, includes a 3D structure or geometry between cells. For example, the bus bar 270 can include a cell contact portion 272 that contacts a cell at a first height or level, and a bridge 275 between cells that spans the cells at a second height or level higher than the first height or level.

Thus, the chassis 110, which can include a two-part clamshell chassis, enables the easy and efficient manufacturing of the pack 100, where the battery cells 120 are positioned within the chassis 110, a bus bar 130 is stamped to connect the cells 120, and a potting compound, such as urethane, is disposed between openings formed by the chassis 110 to fix the cells 120 within the chassis (e.g., by substantially encapsulating the cells 120 with the compound). Thus, the configuration of the chassis 110 facilitates the positioning of the cells, the stamping or application of bus bars or other electric connectors, and the encapsulation of the cells with the potting compound.

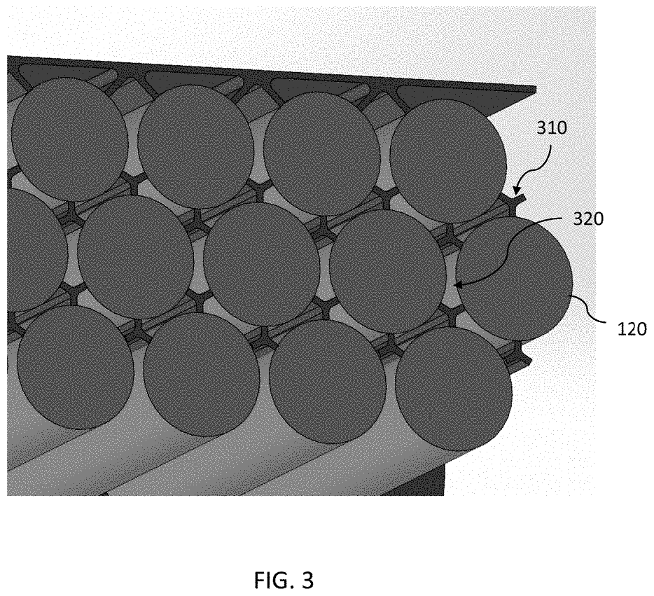

FIG. 3 depicts the spacers that separate the battery cells within the battery pack chassis. A spacer 310 separates three battery cells 120, forming an opening 320 between the cells 120. A potting compound is disposed or added into the opening 320. The potting compound can include urethane or another resin or flowing material, a foam material, and so on. Within the opening 320 (and within all the openings), the potting compound can contact an entire outer surface of the battery cells 120 (or substantially contact or cover the entire surface of the cells 120). For example, the potting compound can contact all areas of the surface that are exposed in the opening 320.

In some cases, the potting compound is most effective when it contacts the entire surface, or most of the surface, of the battery cell 120. The small spacers 310 within the areas of max volume index the cells and allow the potting compound to flow and completely (or mostly) encapsulate the battery cell 120. Thus, cell damage may not propagate thermal runaway to adjacent cells, because of a phase change of the potting compound that absorbs energy from a damaged cell. Further, the cells 120 are also more securely retained in the pack, because there is a large adhesive surface area for the potting compound to contact the cells 120.

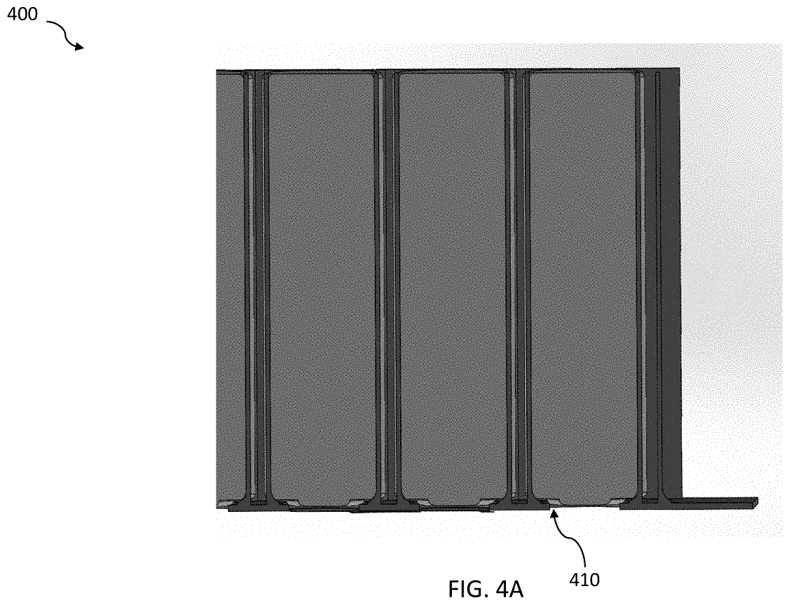

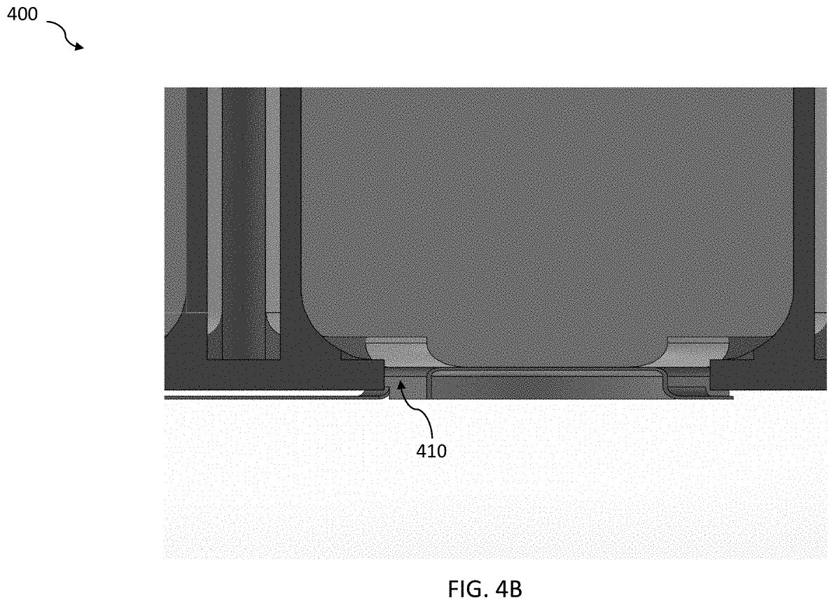

FIGS. 4A-4B are diagrams 400 illustrating a cross-sectional view of cells positioned within the battery pack. The chassis can include radii 410, which provide a datum for the battery to bottom out and allow the potting compound to flow between negative terminals and the chassis. In some cases, thermoplastics can have accelerated creep at high temperatures. Thus, the configuration of the chassis, using the radii 410, enables a thermosetting potting compound to fully capture or move within the chassis, and thus create a stiffer load path between cells.

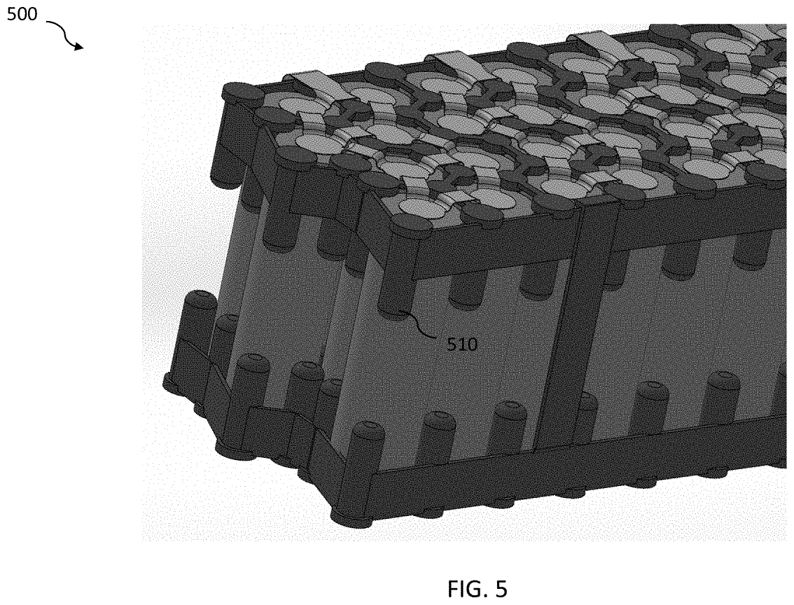

As described herein, the technology can be applied to various configurations or types of battery packs. FIG. 5 is a diagram illustrating a snap-fit battery pack 500. The battery pack 500 includes a snap-fit chassis, and incorporates the spacers and openings described herein, allowing a potting compound to flow between cells during manufacturing.

FIG. 5 also depicts cylindrical spacers 510. The spacers, as described herein, can take on a variety of shapes or geometries. For example, the spacers 115 have a tri-spoke shape, whereas the spacers 510 are cylindrical. The shape can be based on the ease of tooling the chassis, the cost to manufacture the chassis, the desired size or shape of the openings within the pack, the types of cells to be positioned within the chassis, and so on.

Thus, in some embodiments, a battery pack, via an associated chassis having cell spacers, facilitates the manufacturing of battery packs that are safe and secure. The battery pack can include multiple battery cells, a battery chassis configured to hold the multiple battery cells in a vertical orientation proximate to one another, where the battery chassis includes multiple spacers disposed between the multiple battery cells, and a potting compound disposed within openings of the chassis that are formed between the multiple battery cells by the multiple spacers.

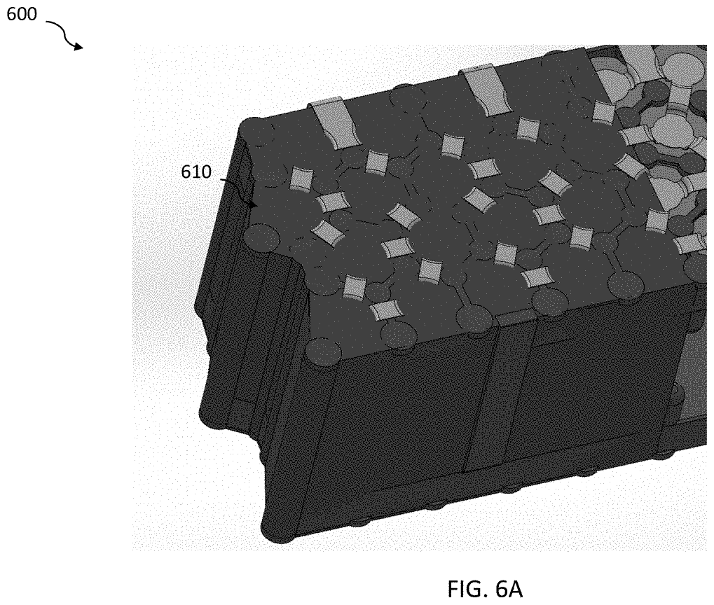

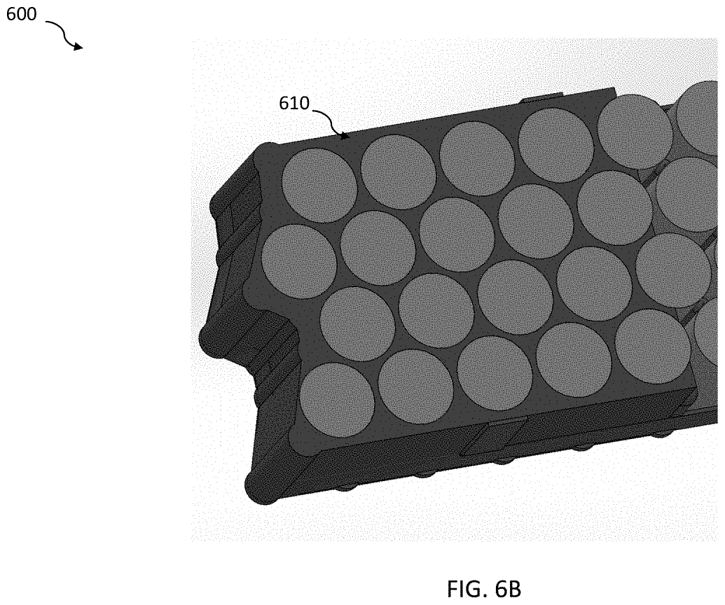

FIGS. 6A-6B illustrate a battery pack 600 after application of a potting compound 610. As shown in FIG. 6A, which is a top view of the pack 600, the potting compound 610 fills in all gaps on the top surface and between the cells. FIG. 6B depicts a middle section of the battery pack 600, where the potting compound completely fills openings between the battery cells.

In some cases, the potting compound 610 can be applied by porting the compound directly into the chassis and around the cells (e.g., directly into the openings of the chassis). For example, depending on the viscosity of the potting compound, the application can be dosed, because the internal volume of the voids or openings can be known before application. Further, the rate of dosing or applying the compound can be regulated to wait for squeeze out at specific locations within the chassis, to ensure adequate wet-out within the openings and to the cells by the compound.

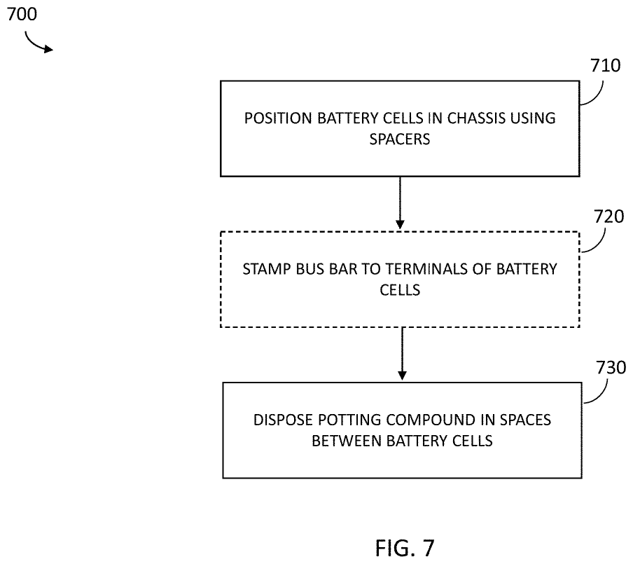

FIG. 7 is a flow diagram illustrating a method 700 of manufacturing a battery pack. In operation 710, the method 700 positions multiple battery cells within a chassis of a battery pack. The cells can be spaced apart by various spacers. As described herein, the spacing between the cells can be symmetric or asymmetric.

In operation 720, the method 700, optionally, stamps a bus bar onto the chassis to connect the battery cells before the potting compound is disposed into the chassis. The bus bar can be two-dimensional or three-dimensional, depending on the structure of the chassis.

In operation 730, the method 700 disposes (e.g., flows) a potting compound within the openings of the chassis that are between the multiple battery cells. For example, disposing the potting compound can include substantially encapsulating each battery cell of the multiple battery cells with the potting compound.

Thus, the technology described herein facilitates the formation or manufacture of a potted battery pack for an electric bicycle or other vehicle, device or apparatus.

### Examples of Asymmetrically Spaced Cells in a Battery Pack

As described herein, in some embodiments, the potting compound functions to mitigate or prevent thermal runaway between cells of a battery pack, as well as to provide rigidity to the battery pack and securely maintain the cells in their positions within the pack.

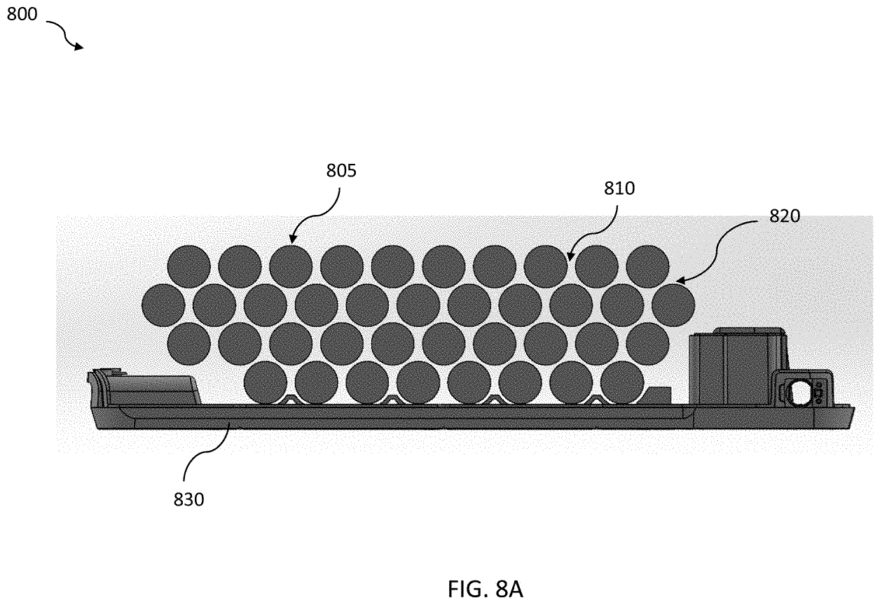

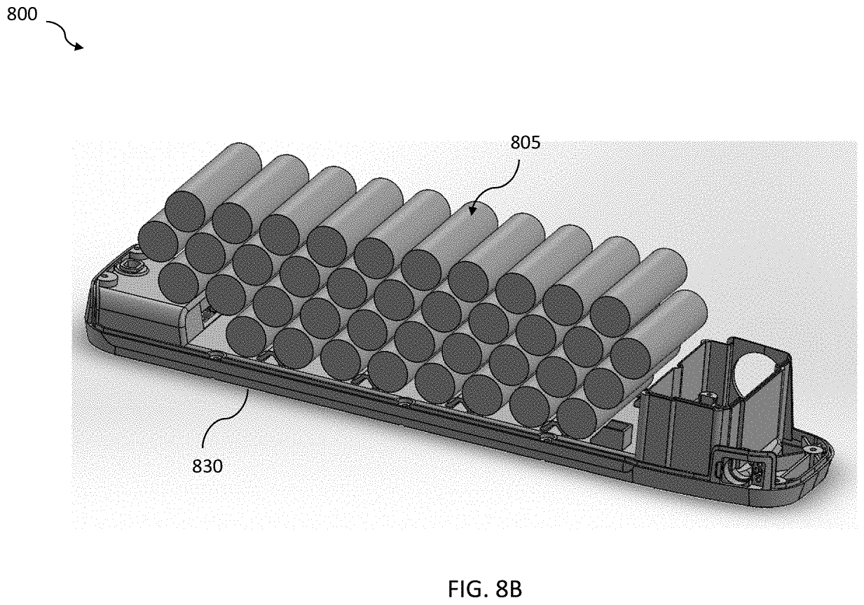

FIGS. 8A-8B are diagrams illustrating a battery pack 800 having asymmetrically spaced battery cells. The battery pack 800 includes battery cells 805, which are spaced from one another in various configurations to fit inside the pack 800. The battery cells are disposed on a sled 830, before the potting compound (e.g., foam, urethane or another resin or flowing material) is disposed between the cells.

As shown in the Figures, a first spacing 810 (e.g., in a horizontal direction) is different than a second spacing 820 (e.g., along a vertical direction) between the cells 805. For example, the first spacing 810 provides a gap between cells 805, while the second spacing 820 allows for overlap of alternating cells 805 in the second direction. In some cases, varying the spacing enables the battery pack 800 to be smaller and/or shaped differently, while still utilizing the potting compound as structural and thermal protection between cells 805. Thus, an asymmetrically spaced pack 800 can enable an optimized use of the potting compound, among other benefits.

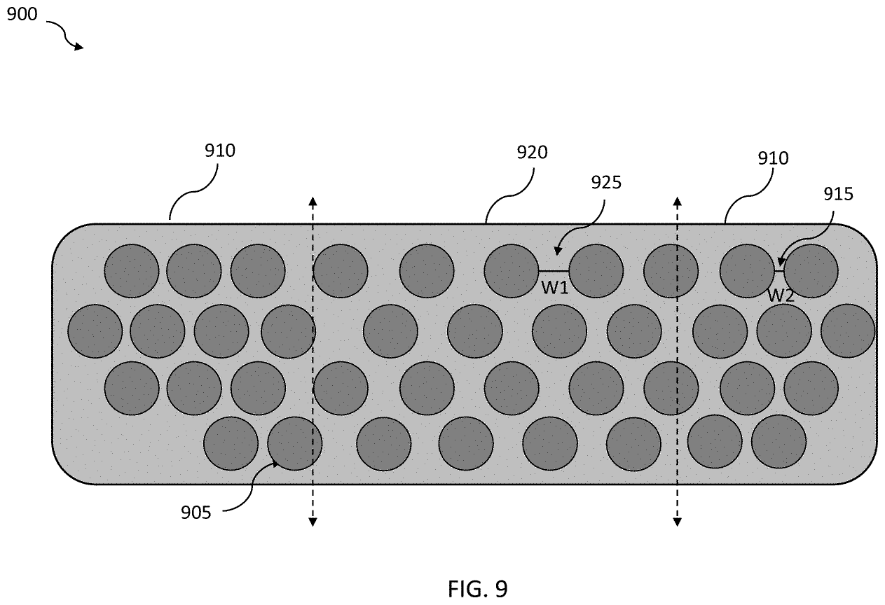

In some embodiments, a battery pack can vary the spacing across different regions or areas of the pack. FIG. 9 is a diagram illustrating battery pack 900 having different cell spacing regions. For example, a middle area 920 of the battery pack 900 can have battery cells 905 with spacing 925 at a certain width (e.g., W1), whereas end areas 910 of the battery pack 900 can have the battery cells 905 with spacing 915 at a different width (e.g., W2).

In some cases, the spacing width 925 of the middle or central area 920 is larger than the spacing width 915 of the end areas 910 (e.g., W1>W2), where the width is measured along the x-axis, as depicted in FIG. 9A. For example, an energy density can be higher in the middle area 920 of the pack 900, and cells are placed or disposed having wider or greater spacing between cells 905 in the middle area 920, with respect to the spacing of cells placed at the end or edge areas. The wider spacing can improve the thermal protection of those middle or center cells because there is more potting compound between cells to protect the cells, where heat/energy can escape from the pack at the end areas with as much potting compound.

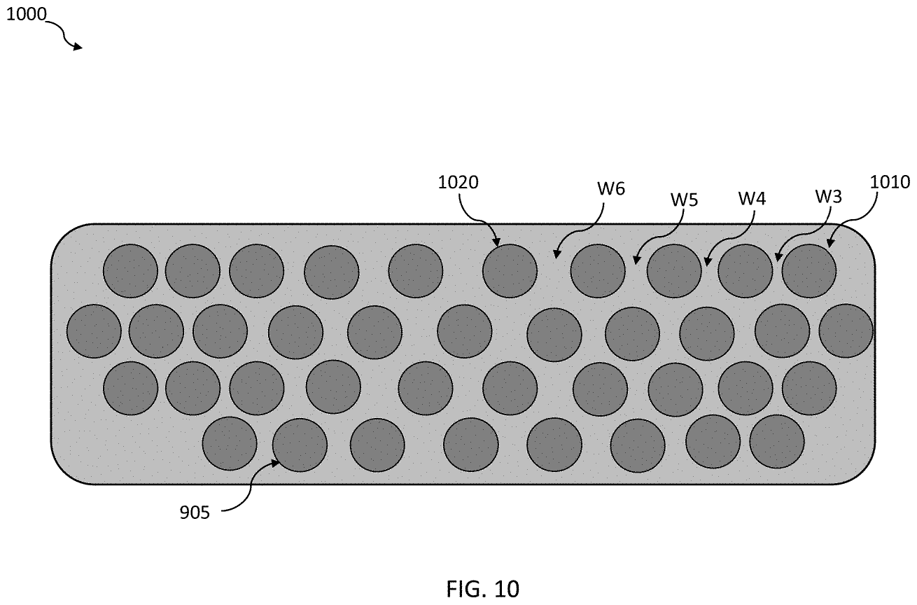

Thus, when the pack has a fixed size and/or shape, cells in areas of higher comparative energy density can be spaced more widely apart than cells in areas of lower comparative energy density. The spacing, therefore, can be eccentric, asymmetric, or otherwise vary by area, by region, or between each cell within a pack. For example, as shown in FIG. 10, the spacing width from an outer or edge column of cells 1010 to the innermost or center column of cells 1020 can vary from narrowest to widest (e.g., W3<W4<W5<W6), respectively.

The variable or eccentric spacing can be in any direction, including horizontal, vertical, orthogonal, in both directions (e.g., both x-axis and y-axis), and so on. Also, the spacing can vary between each cell, such as spacing between proximate cells follows no set pattern, but instead acts to map to heat gradients, energy gradients, and/or potentially structural weak points for a pack. For example, for each cell in a pack, a certain area or volume of potting compound is determined (with respect to the other cells), and the cells are spaced accordingly.

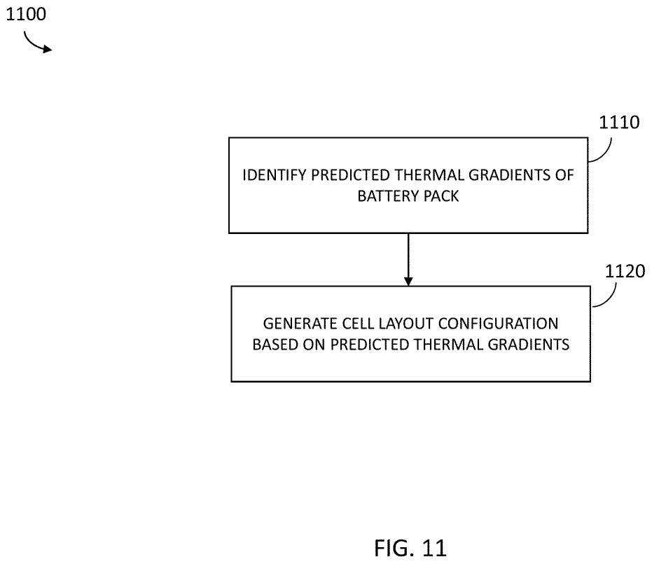

FIG. 11 is a flow diagram illustrating an example method 1100 of determining spacing for cells of a battery pack. In operation 1110, the method 1100 identifies a predicted thermal gradient or gradients for a battery pack. For example, the method 1100 can identify, based on testing of the battery pack, the use of similar packs or cells, and/or the context within which the pack is to be deployed (e.g., what part of a bike or apparatus) to identify, determine, and/or predict thermal gradients for the pack when the pack is in operation. In some cases, the prediction can measure or estimate the PPR properties of different spacings between cells.

In operation 1120, the method 1100 generates a cell layout configuration based on the predicted characteristics. For example, the method 1100 can generate a layout configuration that includes areas or zones of different cell spacing or widths (e.g., as depicted in FIG. 9), a layout configuration that include a spacing gradient or pattern (e.g., as depicted in FIG. 10), a layout configuration that includes a unique spacing geometry for some or all cells (or groups of cells) in a pack, and so on. Further, the method 1100 can utilize or identify the size or volume of the battery pack housing, and base the cell layout configuration, at least in part, on the battery pack size/volume parameters.

Thus, the design or configuration of the battery cells in a battery can include various spacing widths, patterns, and/or geometries that enhance or improve the PPR (passive propagation resistance) of the pack and mitigate cell to cell thermal runaway propagation between cells, among other benefits.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or”, in reference to a list of two or more items, covers all of the following interpretations of the word: any of the items in the list, all of the items in the list, and any combination of the items in the list.

The above detailed description of embodiments of the disclosure is not intended to be exhaustive or to limit the teachings to the precise form disclosed above. While specific embodiments of, and examples for, the disclosure are described above for illustrative purposes, various equivalent modifications are possible within the scope of the disclosure, as those skilled in the relevant art will recognize.

The teachings of the disclosure provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further embodiments of the disclosure.

These and other changes can be made to the disclosure in light of the above Detailed Description. While the above description describes certain embodiments of the disclosure, and describes the best mode contemplated, no matter how detailed the above appears in text, the teachings can be practiced in many ways. Details of the electric bike and bike frame may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

From the foregoing, it will be appreciated that specific embodiments have been described herein for purposes of illustration, but that various modifications may be made without deviating from the spirit and scope of the embodiments. Accordingly, the embodiments are not limited except as by the appended claims.

What is claimed is:

1. A battery pack, comprising:
multiple battery cells;
a battery chassis configured to hold the multiple battery cells in a vertical orientation proximate to one another,
wherein the battery chassis includes multiple spacers disposed between the multiple battery cells; and
a potting compound disposed within openings of the chassis that are formed between the multiple battery cells by the multiple spacers.

2. The battery pack of claim 1, wherein the openings of the chassis that are formed between the multiple battery cells by the multiple spacers extend from a top surface of the chassis to a bottom surface of the chassis, and wherein the potting compound is disposed within the openings to contact an entire surface of each cell of the multiple battery cells.

3. The battery pack of claim 1, wherein the potting compound is a urethane-based potting compound.

4. The battery pack of claim 1, wherein the chassis includes a top surface having holes that provide access to negative terminals of each of multiple battery cells, the battery pack further comprising:
a bus bar, stamped onto the top surface of the chassis, that connects the negative terminals of each of the multiple battery cells.

5. The battery pack of claim 1, wherein the multiple spacers include ribs that extend in the vertical orientation,
wherein at least one rib is positioned to contact and separate three battery cells of the multiple battery cells from one another.

6. The battery pack of claim 1, wherein the multiple spacers disposed between the multiple battery cells include:
a first spacer having a first width that is disposed between battery cells within a first area of the battery pack; and
a second spacer having a second width, greater than the first width, which is disposed between other battery cells within a second area of the battery pack.

7. The battery pack of claim 1, wherein the multiple spacers disposed between the multiple battery cells include:
a first spacer having a first width that is disposed between battery cells within a center area of the battery pack; and
a second spacer having a second width larger than the first width that is disposed between other battery cells proximate to an end of the battery pack.

8. A method of manufacturing a battery pack, the method comprising:
positioning multiple battery cells within a chassis of the battery pack,
wherein each battery cell of the multiple battery cells is spaced apart from the other battery cells by spacers of the battery pack in an asymmetric configuration; and
disposing a potting compound within openings of the chassis that are between the multiple battery cells.

9. The method of claim 8, wherein disposing a potting compound within openings of the chassis that are between the multiple battery cells includes substantially encapsulating each battery cell of the multiple battery cells with the potting compound.

10. The method of claim 8, further comprising:
before disposing the potting compound within the openings of the chassis, stamping a bus bar onto a top surface of the chassis to connect negative terminals of the multiple battery cells to one another.

11. The method of claim 8, wherein positioning multiple battery cells within a chassis of the battery pack includes:
placing a first set of battery cells in a first area having a first width spacing between the battery cells of the first set of battery cells; and
placing a second set of battery cells in a second area having a second width spacing between the battery cells of the second set of battery cells,
wherein the second width spacing is greater than the first width spacing.

12. The method of claim 8, wherein positioning multiple battery cells within a chassis of the battery pack includes:
placing a first set of battery cells in a central area having a first width spacing between the battery cells of the first set of battery cells; and
placing a second set of battery cells in an end area having a second width spacing between the battery cells of the second set of battery cells, wherein the second width spacing is smaller than the first width spacing.

13. An apparatus, comprising:
a battery chassis configured to hold multiple battery cells in a vertical orientation proximate to one another, the battery chassis including:
a top surface that facilitates connecting the multiple battery cells to one another via a stamped metal connector; and
multiple spacers disposed between the multiple battery cells to form openings between the multiple battery cells.

14. The apparatus of claim 13, wherein the multiple spacers include ribs that extend in the vertical orientation and are positioned to contact and separate three battery cells of the multiple battery cells from one another.

15. The apparatus of claim 13, wherein the multiple spacers include:
a first spacer having a first width; and
a second spacer having a second width greater than the first width.

16. The apparatus of claim 13, wherein the battery chassis is configured to space the multiple battery cells in an asymmetric configuration.

17. The apparatus of claim 13, wherein the battery chassis includes two or more areas, including:
a first area holding a first portion of the battery cells in a first geometric configuration; and
a second area holding a second portion of the battery cells in a second geometric configuration.

18. The apparatus of claim 13, further comprising:
a potting compound disposed within the openings between the multiple battery cells that encapsulates the multiple battery cells.

19. The apparatus of claim 13, wherein the multiple spacers disposed between the multiple battery cells have a cylindrical shape or a tri-spoke shape.
